(19) United States
(12) Patent Application Publication
(10) Pub. No.: US 2021/0108376 A1
(43) Pub. Date: Apr. 15, 2021

(54) ARTIFICIAL TURF FIELD APPARATUS AND METHODS

(71) Applicant: Tarkett Sports Canada, Inc., Montreal (CA)

(72) Inventor: Nicolas Aumonier, Montreal (CA)

(21) Appl. No.: 17/086,185

(22) Filed: Oct. 30, 2020

Related U.S. Application Data
(63) Continuation-in-part of application No. 16/859,838, filed on Apr. 27, 2020.
(60) Provisional application No. 62/841,193, filed on Apr. 30, 2019.

(51) Int. Cl. E01C 13/08; B29C 45/26

(52) U.S. Cl. CPC E01C 13/08; B29K 2101/12; B29C 45/2626

(57) ABSTRACT

Apparatus and methods are provided for providing an artificial turf system having an array of integrated fibers and base arrangement. The fibers can be integrally formed with a substrate, for example, by using a molding process. The fibers can be formed to be bonded directly to the base using molecular bonds of the material that formed the base and the fibers at the same time.

### CROSS REFERENCE TO RELATED APPLICATION

This application is a continuation-in-part application of and claims the benefit of U.S. patent application Ser. No. 16/859,838, filed on Apr. 27, 2020, which claims the benefit of U.S. Provisional Application No. 62/841,193 filed on Apr. 30, 2019, the disclosure of each of which is expressly incorporated herein by reference thereto.

### FIELD OF THE INVENTION

The present invention is related to artificial turf fields.

### BACKGROUND OF THE INVENTION

Artificial turf fields have been in use for many years and have gained special popularity in in athletic playing surfaces. The grass like fibers and supporting infill provide performance and maintenance advantages over natural grass fields, and have a long but limited life. In implementation, artificial turf fields for athletic surfaces must typically meet certain performance characteristics including the specific ability to absorb shock (impact) at a level or range (designated for that field or sport). Conventional techniques for forming artificial turf fields involve extruded fiber that is tufted and glued to backing. These known prior art techniques have various deficiencies and there is a desire to develop new apparatus and method for artificial turf fields.

### SUMMARY

In accordance with embodiments of the present invention, an artificial turf field that provides a playing surface of grass fibers can be provided. The artificial turf field can comprise a substrate made of a thermoplastic polymer, wherein the substrate comprises grass-shaped protrusions integrally formed with the substrate and the grass shaped protrusions are adapted to extend upwardly from the substrate to provide artificial grass fibers for the playing surface of the field. The substrate can be referred to as a base or tile. The artificial turf field can further comprise a plurality of mats that are used to mount the substrate and place the turf on the field. The artificial turf field can have protrusions that are adapted to have a circular cross section. Other shapes of cross section are also contemplated such as oval, square, triangular, or star cross section. The artificial turf field can be configured to have the substrate provide the primary support for the protrusions. The protrusions can be held in place to the substrate by the molded formation of the protrusions with the substrate. The protrusions can be adapted to be have visual physical properties that are similar to natural grass. The artificial turf field can comprise infill particles that are interspersed between the protrusions.

The substrate and protrusions can be adapted to match predetermined field performance characteristics. If desired, the protrusions are formed to have varying lengths. A plurality of the protrusions can be adapted to have physical properties that cause each protrusion to bend because the protrusion has flexibility that allows the bend based on the weight of the protrusion in relation to the length of the protrusion. The protrusions can be substantially (e.g., meaning at least 85%) all of the grass fibers for the field. The protrusions can be distributed over a surface of the substrate at a density that visually simulates a grass field.

Each protrusion involves a continuous surface transition from a top surface of the substrate to side surfaces of the protrusion.

The protrusions that provide the grass fibers can be adapted to have properties that cause a small percentage of the protrusions to break or break away when subject to use as an athletic surface over eight years.

A method can be provided for forming artificial grass fibers, comprising providing a thermoplastic polymer (elastomeric polymer); and integrally forming from the thermoplastic polymer a substrate and grass-shaped protrusions extending from a surface of the substrate. The method can include providing a mold that is shaped to form the substrate and grass-shaped protrusions. The substrate and grass shaped protrusions are made of soft polymers, such as thermoplastic elastomer (TPE), olefin, thermoplastic olefin (TPO), and other similar materials. The present preferred material is SEBS. The method can be used in producing an artificial turf field. Integrally forming can comprise forming a continuous surface traversing a top surface of the substrate to a side of each protrusion. This can include a physical junction formed due to the shape of a mold.

In accordance with some embodiments, an artificial turf system is provided that provides a playing surface for conducting an athletic or sporting activity. The system comprises a plurality of soft polymer molded artificial turf panels, wherein each of the panels has edges and comprises one or more connectors that connect to an adjacent one of the panels, each of the panels comprising an array of artificial turf fibers, each of the fibers has and retains a shape memory that adapts each of the fibers to have an upright state in an unbiased state and each of the fibers is also freely pliable. The panels are connected adjacent to each other to form a field of the artificial fibers that together establish the playing surface on the field for an athletic or sporting activity. The artificial turf system can be configured to have each of the fibers terminates at a supporting surface of the panel at the same level of termination, wherein the termination is around the perimeter of the fiber. The artificial turf system may include a supporting surface that is in a supporting relationship that projects each of the fibers individually upwards. The artificial turf system can include molded artificial turf panels, each of them including molded cells that includes a plurality of open cells formed from panel underside walls that absorb shock and provide deformation when the panel is in use. The artificial turf system can include fibers that are long thin fibers that taper from a terminating position to a tip of the fiber. The artificial turf system can be adapted to have a support surface that is generally flat and each of the fibers terminates at the support surface. The artificial turf system can include panels that are configured to include flanges that overlap when adjacent panels are connected. The panels can be configured to have different shaped cells on the bottom of each of the panels. An array of adjacent cells is formed on the bottom side of each of the panels. The fibers can be made of the same material as its attached base, forming a single panel. The formed fibers can have an excellent memory form (shape memory) and have the capability to stay upwards when exposed to stepping.

In accordance with some embodiments of the present invention, a method providing an artificial turf field is provided, comprising providing a mold comprising an array of separate cylinders, each cylinder for forming an individual freely pliable fiber and an integrated attached shock absorbing support substrate from which the each fiber would project upward due to the supporting relationship of the substrate as a base for the each fiber, injecting melted elastomeric polymer into the mold and applying pressure to the injected material, cooling the injected polymer in the mold to form an artificial turf panel formed as a solid piece comprising an array of molded fibers molded at the same time with the substrate, wherein the fibers are freely pliable; and removing the panel from the mold. Each of the molded fibers is formed to be individual and distinct (as shown herein) and terminate at a generally flat surface of the support substrate. The elastomeric polymer can be SEBS. The elastomeric polymer can have a hardness equal to Shore A in the range of 40 to 80. The method further comprising placing the panel on a field as part of artificial turf field for an athletic activity without applying any additional industrial steps or additional deformation treatment to the fibers. The method can further comprise interspersing infill between the fibers when installing the panel on a field. The mold can be adapted to form flanges on the panel, which in use are used in connecting adjacent panels. The method can include forming one or more connecters at one or more edges of the panel that connect the panel to adjacent similar panels.

In accordance with some embodiments, a shock absorbing artificial turf panel is provided comprising a panel including (as shown herein) a top side, bottom side, and edges, the top side comprising an array of freely flexible fibers that are adapted to provide a playing surface and a base that supports the fibers to be in an upright relationship by molding the base and the fibers, wherein the fibers are and base are made of the same elastomeric polymer. The fibers and base are made of the same elastomeric polymer that has a hardness in the range of 40 to 80 Shore A. The entire panel can be made of the same elastomeric polymer in a single molded structure. The fibers can have a circular cross section and have a profile that is thicker at the base than at a tip of the fiber. The panel can be configured to include cells positioned on the bottom side of the panel that provide shock absorption from foot impact. The panel can include one or more connectors at the edges of the panel that are configured to connect to similar adjacent panels. The base can be a generally flat surface exception for attachment points of the fibers. The fibers can be configured to be equally spaced apart on the base. Each of the fibers can terminate at the base at the same height or level.

Apparatus and methods are evident to those of skill in the art from the description herein without specifying that it is describing an apparatus, or method.

### BRIEF DESCRIPTION OF THE DRAWINGS

Various features of examples in accordance with the principles described herein may be more readily understood with reference to the following detailed description taken in conjunction with the accompanying drawings, where like reference numerals designate like structural elements, and in which:

FIG. 1 is a diagram of perspective view of a plurality of artificial turf panels that are assembled together in accordance with an embodiment of the present invention;

FIG. 2 is a diagram of a side view of a plurality of artificial turf panels in accordance with an embodiment of the invention;

FIG. 3 is a diagram an expanded view of FIG. 2 in accordance with an embodiment of the invention;

FIG. 4 is a diagram of a perspective view of a cross-section of a panel in accordance with an embodiment of the invention;

FIG. 5 is a diagram of a top view of a plurality of panels in accordance with an embodiment of the invention;

FIG. 6 is a diagram of an expanded view of a portion of FIG. 5 in accordance with an embodiment of the present invention;

FIG. 7 is a diagram of an image of a product in accordance with an embodiment of the present invention;

FIG. 8 is a diagram of an expanded image of a product in accordance with an embodiment of the present invention;

FIG. 9 is a perspective view of an artificial turf panel in accordance with an embodiment of the present invention;

FIG. 10 is a perspective view of an artificial turf panel in accordance with an embodiment of the present invention;

FIG. 11 is a cross-sectional view of a portion of an artificial turf panel in accordance with an embodiment of the present invention;

FIG. 12 is a cross-sectional view of a portion of an artificial turf panel with infill in accordance with an embodiment of the present invention;

FIG. 13 is a perspective of a fiber as part of an artificial turf panel in accordance with an embodiment of the present invention;

FIG. 14 is a perspective view of a bottom of an artificial turf panel in accordance with an embodiment of the present invention;

FIG. 15 is a top view of an artificial turf panel in accordance with an embodiment of the present invention;

FIG. 16 is a bottom view of an artificial turf panel in accordance with an embodiment of the present invention;

FIG. 17 is a side view of an artificial turf panel in accordance with an embodiment of the present invention;

FIG. 18 is a side view of a cross section of an artificial turf panel in accordance with an embodiment of the present invention;

FIG. 19 is a simplified diagram illustrate a portion of the mold for a panel in accordance with an embodiment of the present invention;

FIG. 20 is a top view of a portion of an artificial turf panel in accordance with an embodiment of the present invention;

FIG. 21 is a side view of a cross section of a portion of an artificial turf panel in accordance with an embodiment of the present invention, and

FIGS. 22 and 23 are photographic images of the mold using in making an artificial turf panel in accordance with an embodiment of the present invention,

The illustrations are drawn to be illustrative and are not scientific drawings.

### DETAIL DESCRIPTION OF THE INVENTION

The convention in artificial turf fields is that extruded artificial fibers are cut and tufted through a woven backing. This has been the convention and the techniques used across all known artificial turf fields for athletic playing field for decades. The use of tufted fibers on backing to provide such a field is the overwhelming convention and approach in the industry for providing such fields. In conventional techniques, the backing is a woven backing that is included in the structure and provides the attachment point for securing the artificial turf fibers for the field. The extrusion process involves extruding a material through a die that shapes the cross section of the fiber as it is extruded. In implementation, the attachment of the fiber to the base by the tufting process implements a relationship with the objective of attachment, not support. In use, conventional artificial turf fibers are easily flattened through use of foot traffic and do not include the spring characteristic or base attachment that repeatedly springs the fiber to an upright position.

In accordance with the principles of the present invention, new artificial turf fields are provided. Embodiments of the present invention involve forming artificial turf fibers without extruding the fiber but rather using a molding or similar process to form grass fibers that extend from a base. There is also no need for a woven or similar artificial turf backing that is used in conventional turfs and it can be eliminated. The grass fibers formed by embodiments of the present invention may be referred to as strands or fibers. The base and grass fibers are for example formed at the same time, with the same polymer. If desired, the integrally formed fiber and base can be placed on a support structure such as by being mounted on a mat and placed on a field. This arrangement can be spread over a field to form a new type of artificial turf field. If desired, the fiber can be formed (e.g., molded) separately, connected together with a thin sheet of the same material as the strands. Then this sheet comprising strands can be laid over conventional pads.

Soft thin long fibers are formed by molding an artificial turf panel. The fibers are thin and easily pliable and at the base of each fiber, the fiber is formed to be projected upward by the attachment relationship at the terminating point or base of the fiber with the supporting surface of the panel.

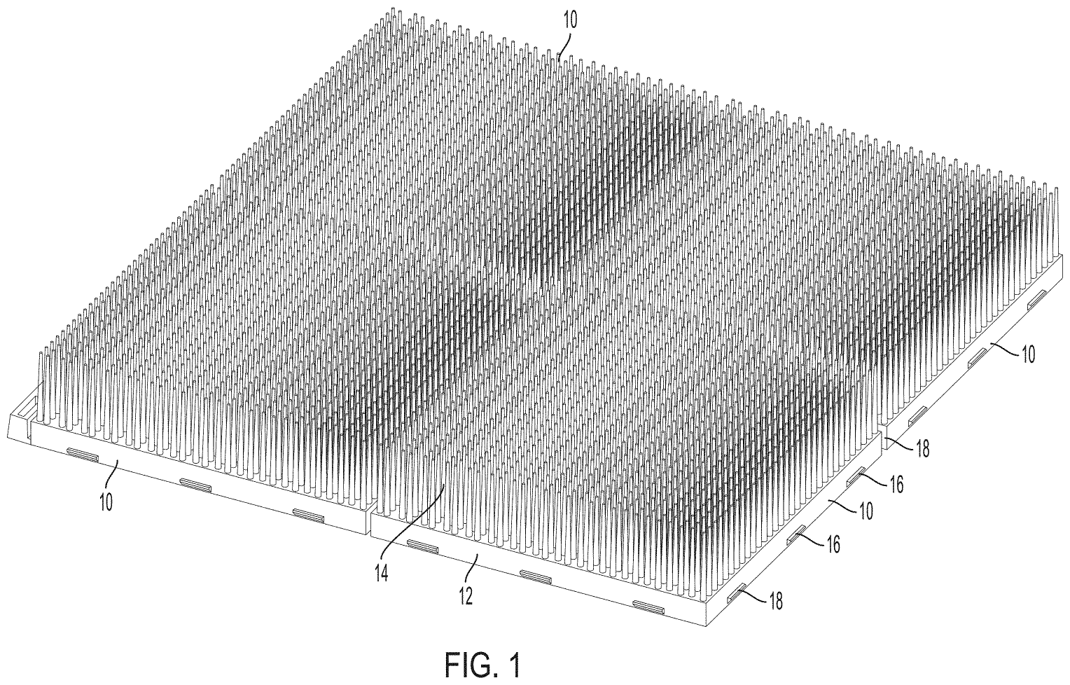

With reference now to FIG. 1, a plurality of panels 10 (as shown four panels) are provided. Panels 10 are arranged to form a playing surface and, in implementation on a field, many panels 10 are arranged in the same fashion to form the playing field. Each panel 10 comprises base 12 and artificial grass fibers 14. Base 12 comprises three connectors 16 (e.g., male/female connectors) on each side of each panel 10, which are used to assemble the panels 10. Artificial turf fibers 14 are made from protrusions that extend from the top surface of panel 10. There are many fibers 14 positioned and distributed on each panel 14. Base 12 can comprise a substrate. A particular thickness in relation to the fibers is shown in FIG. 1 but different thicknesses are contemplated. Each base 12 and its grass fibers 14 are integrally formed. For example, a mold is provided that is shaped to form panel 10 including base 12 and protrusions (grass fibers 14). When thermoplastic polymer (elastomeric) material is added to the mold, base 12 and fibers 14 are integrally formed.

FIG. 1 is a CAD drawing of panels 10. The panels 10 when produced may have fibers 14 that are leaning or bent, or may appear bent due to the physical properties of the material and the geometric shape of the fibers. An example of this is provided further below. Also as shown, gap 18 is illustrated between each adjacent panel 10. The size of gap 18 can vary. In some embodiments, gap 18 is beneficial for providing water drainage.

Panels 10 may be placed directly on a surface of a field to form the artificial turf field. In some embodiments, a support structure or mat is provided that is used to mount or form a base for panels 10 and the combined arrangement is placed on a surface of a field to form the artificial turf field.

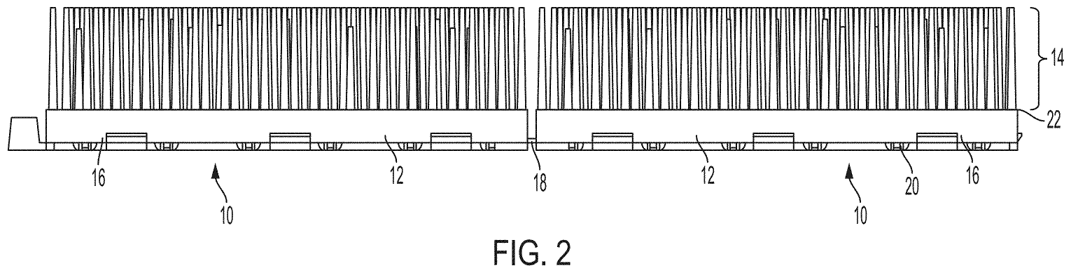

With reference now to FIG. 2, a side view of panels 12 is provided. As shown, fibers 14 have generally uniform height as measured from the top surface 22 of the base 12. In this embodiment, support 20 that is a foot, pin, or bump can be formed as part of base 12. Support 20 touches a support surface such as the field. Support 20 may if desired be part of a mat that holds or supports panel 10. As shown, each fiber 14 can be the same height but this can be varied by design or after the turf is in use due to wear.

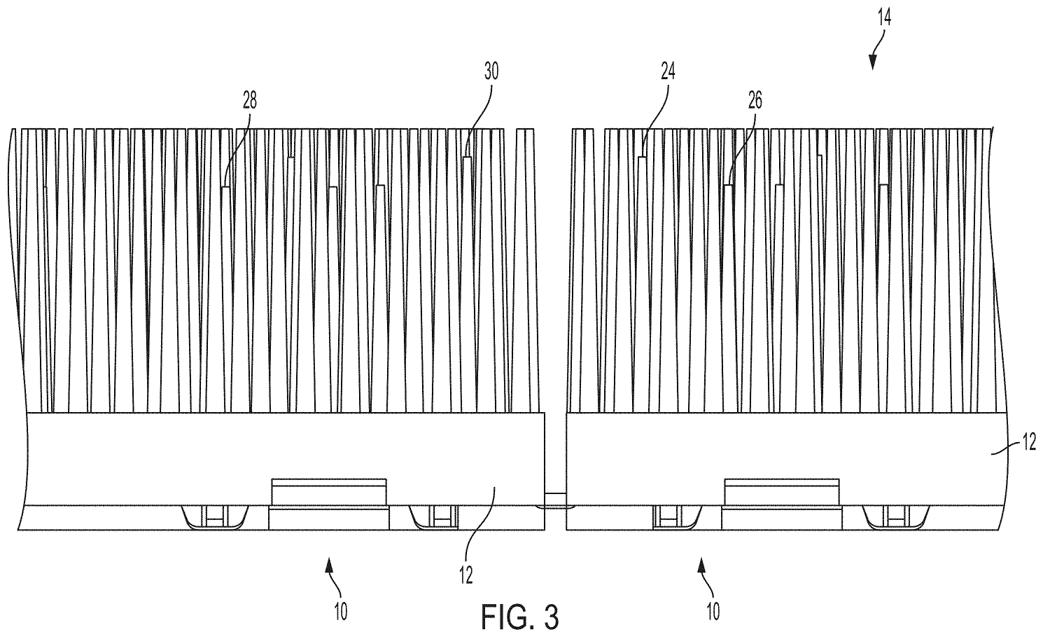

With reference now to FIG. 3, an expanded side view of a portion of FIG. 2 is provided. A portion of two panels 10 are illustrated. As shown in this diagram, fibers 14 can have varying heights 24, 26, 28, and 30. Heights can vary between about 4 mm and about 60 mm, but more commonly around 25 mm.

As such, fibers 14 when produced for use can have differing heights which can provide a level of visual randomness which can be useful in visually stimulating natural grass. As shown, fibers 14 are formed to have the same general structure. A round protrusion that extends upwards and slowly narrows to a flat tip is illustrated. Other shapes or cross sections are contemplated. The varying heights can be by design either for example by varying the shape of the mold or with the expected estimation that an expected percentage of the fibers ends might not fully exit the mold and a portion may break when the fiber is being removed.

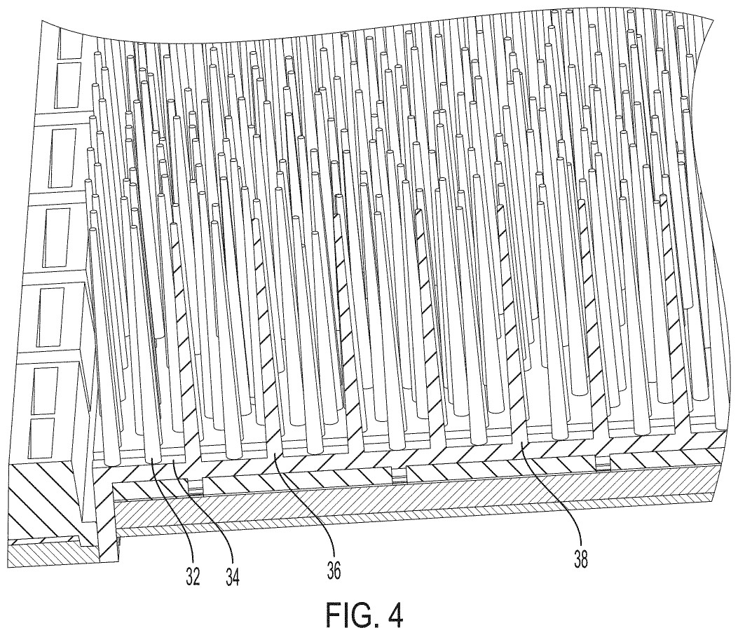

FIG. 4 illustrates a perspective view of a cross section of panel 10. In the illustrated FIGS. 1-3, base 12 and fibers 14 are integrally formed. A line (32) is illustrated at the point at which the grass-like fiber protrude from the surface (34) of the base. This may be formed by for example the shape of mold even though the material is continuous from the base to the sides of the fiber. The integral formation of the fiber and the base (e.g., surface of the base) establishes a continuous surface of material that transitions from the surface of the base to the sides of the fiber. In FIG. 4, a cross section of some fibers (36, 38) are illustrated to demonstrate that the fibers are integral with the base. The lines showing the junction or intersection around the bottom of the fibers is for reference of the physical shape. The junction or intersection is preferably not a junction that may exist if the fiber and base are separately formed and then combined through some form of operation. In some embodiments, a physical line may appear based on the shape or structure of the mold (e.g., by design) while the base and fiber are integrally formed. A continuous and direct bond of the same thermoplastic polymer would exist between the material in the fiber and the base because of the way they were integrally formed together.

The common and the known technique for producing turf fields involving tufting extruded fibers through a woven backing and using an adhesive on the bottom of the backing (glue fiber and backing). In embodiments of the present invention, the fibers are attached to the base or “backing” by way of being integrally formed with a substrate. The application of a glue or adhesive to the back of the backing or bottom surface is not necessary in embodiments of the present invention. The base or substrate supports and holds the fiber in place because of the bond between the thermoplastic material that together formed both the fiber and base together. The base plays also the role of a mat, providing shock absorption properties. The base can have a different thickness between 2 mm and 25 mm, such as about 12 mm. If desired, the base can be formed using one type of polymer and the fibers can be formed using another type of polymer, for example using overmolding technology. This allows the capability to choose the appropriate material for the base and fibers, providing adequate mechanical and physical properties.

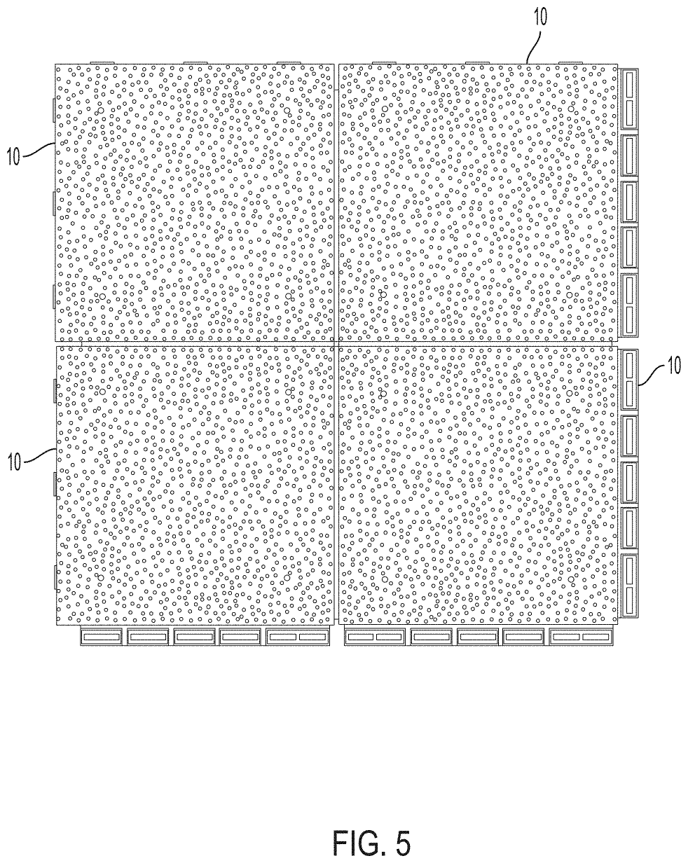

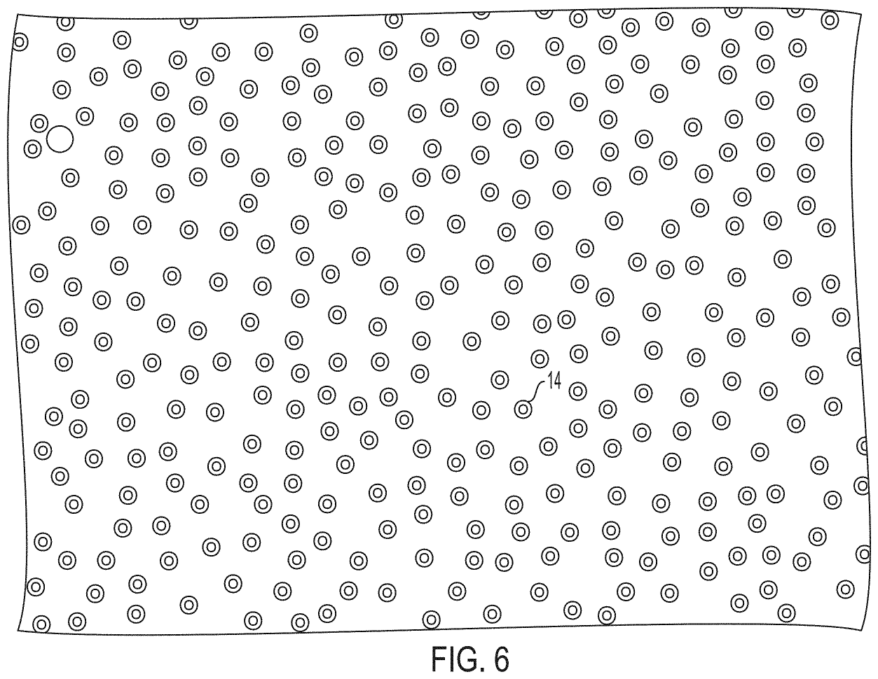

FIG. 5 is an illustrative top of view of a plurality of panels 10 arranged together to form a portion of a field. As shown, many points are provided on the surface of the panels 10 which correspond to fibers 14. FIG. 6 is an expanded view of a portion of FIG. 5. FIG. 6 shows that each fiber 14 from a top view involves an inner circle and an outer circle. Fiber can have a cylindrical, conical, or another shape. As noted, the outer circle corresponds to the transition between the sides of the fiber and the top surface of the base. The fibers are distributed throughout the surface at a density that is sufficient based on the physical characteristics of the fiber and the base (made of the same thermoplastic elastomer, for example, but they can also be made of different types of elastomer or polymer) (and any other part of the turf field) to provide the preplanned physical properties for that field such as providing a desired level shock absorbance (e.g., specific to a particular sport). The number and distribution of fibers can be planned to be sufficient to provide visual similarity to a natural grass field. Random or substantially random positions can be used to mimic a natural field.

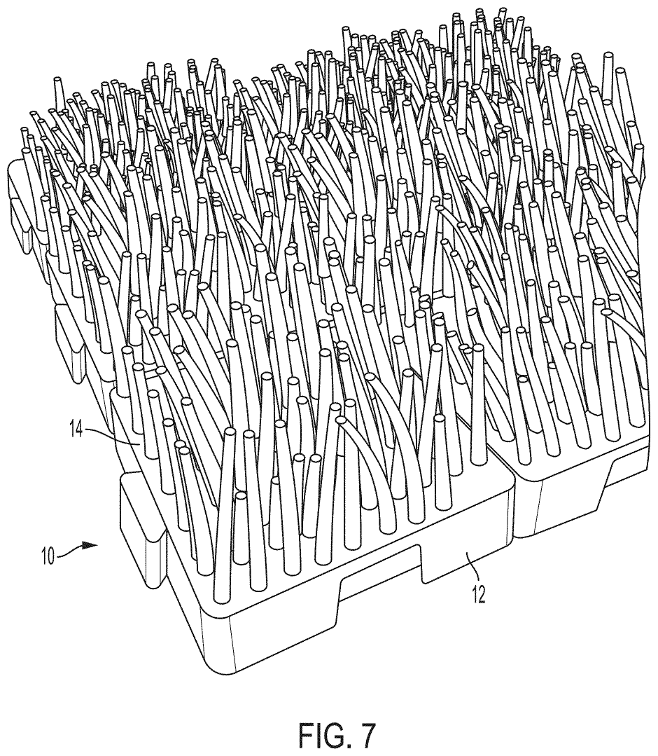

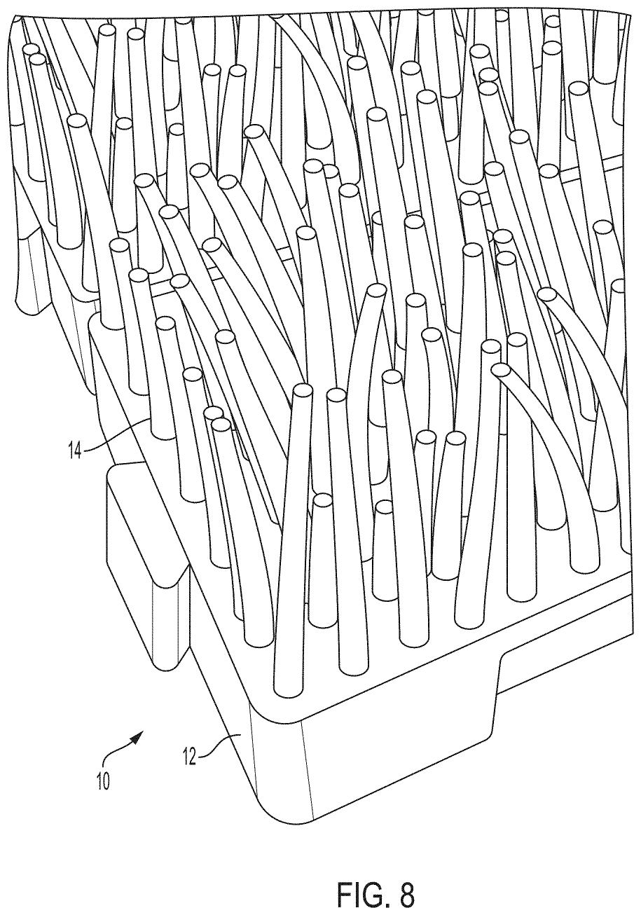

FIG. 7 is a diagram of an image of a test product that was prepared by molding fibers 14 and base 12 together to form panel 10. FIG. 8. is an expanded view of a portion of FIG. 7. As shown, fibers 14 extend from the base and are integral with the base. Fibers 14 have varying heights which can be due to some fibers breaking when they were being removed from the mold, or due to the mold structure itself. The fibers 14 are slightly narrowed as they extend about the base. The formulation of the material and the shape and height of the fibers 14 can be planned to adapt the fiber 14 to be flexible or pliable, or to naturally lien or bend due to the weight of the fiber. They can also be formulated such that they can be groomed in that they can be moved to different positions without springing back to their original position but rather maintaining a groomed position. The fibers can have a level of elasticity preferred for a desired application. Meaning that the fibers can be adapted to have a level of elasticity such that they may spring or revert towards a position when an amount of force is applied (e.g., when a player is running on the field, the fibers are pushed down (potentially compressed), and when force is removed, they revert towards a baseline position which is not necessarily being upright but rather a drooping on lightly leaning position similar to natural grass).

Those of ordinary skill in the art are familiar with the materials and compositions for forming artificial turf fibers such as by using polypropylene and would be able to make modification or variations based on application or need.

Embodiments of the present invention can be made by creating a mold and injecting melted thermoplastic elastomer into the mold and allowing the material to cool down and take the shape of the mold. A desired thermoplastic polymer is used and injected which when processed results in integrally forming the base (or substrate or mat) and fibers (strands) using the mold. Other techniques can include overmolding, e.g., using an insert such as prefabricated pad that is then overmolded using described technology or molding over an existing piece of structure or a prefabricated pad. The structure can be used in conjunction with a mat or support structure to be placed on a field in order to install a new artificial turf field. The integrally formed structure can involve a continuous surface from the top of the substrate to the sides of the fibers with potential a physical indentation cause by the shape of the mold at the base of the fiber and the top surface.

Examples of the ranges of dimensions for the fibers include the fibers having a height in the range of about 4 mm to 50 mm. The fibers can have varying thickness such as in the range of about 0.5 mm to 15 mm, and preferably in the range of about 3.0 mm to 1.0 mm, and more preferably in the range of about 2.0 mm to 1.8 mm. The rigidity or flexibility of individual fibers (based on the material and physical characteristics) can be in the range of about Shore A 30 to shore A 90, and preferably in the range of about Shore A 40 to Shore A 70. To clarify, the material that the fibers or panel are made of or meet the specified Shore A characteristic, which imparts the required flexibility and softness based on the physical fiber structure. The combination of the structure and hardness can adapt the fiber to have the predetermined operational characteristic of the fiber that is desired as part of the panel when made or in use. The base or substrate can have a thickness (from bottom to top) in the range of 2 mm to 40 mm, which can depend on the thickness of the supported fibers and the application. Preferably the base, which can include an integrated pad and support structures such as cells can have a thickness (height) of about 8 to 25 mm.

The techniques for making the above described structures can include molding, overmolding, thermo-forming, continuous molding, or other methods.

Materials that can be used for making the fibers and/or base can be, for example, elastomeric resins or rubbery resins, such as thermoplastic elastomers, thermoplastic olefin and polyolefin, TPO, ethylene vinyl-acetate, or metallocene type elastomers. The material for making the fibers and/or base is preferably styrene copolymers more likely SEBS or SBS. The grade can be modified by those of ordinary skill in the art in preparing the compound based on application. The material used is preferably a thermoplastic, not a thermoset. The material can be an elastomeric polymer which is in general indicates that it is a soft material based on the use of the term elastomeric. The elastomeric polymer can be polyethylene such as a type of SEBS.

In some applications, the fibers and base (or substrate) can be formulated to provide better shock absorbency properties compared to conventional artificial turf field. For example, this may permit, a different type of infill and may require less infill.

Infill particles can include resilient particles such as crumb rubber or other similar material (e.g., crumbled elastomeric material having similar properties). Other particles or types of particles can be in the infill layer such as sand, cork, TPE, EPDM, or other material. An infill layer can include two or more layers and can involve different materials mixed to form a single layer.

Further explanations and implementations related to the above figures and additional embodiments are provided by the following figures which are understood to have one or more common features in relation to each other as would be understood by those or ordinary skill in the art. The above descriptions would also be understood based on the description to contemplate or describe features of the below figures.

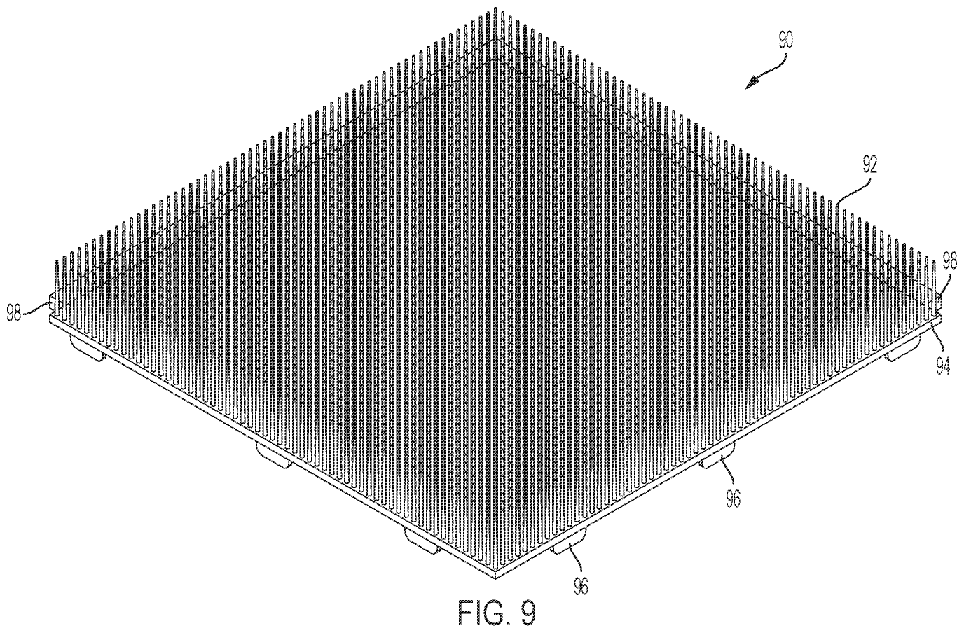

FIG. 9 illustrates a perspective view of an artificial turf panel in accordance with some embodiments of the present invention. Artificial turf panel 90 that is a molded structure (using a mold). Panel 90 is adapted to include a top surface having molded artificial turf fibers and a support surface from which the turf fibers extend upward. The support surface is made of a substrate that is molded at the same time with the fibers and includes top surface, bottom surface, and edges. The top surface is flat or generally flat (meaning there may be very small or minor texture or variation in height but is at the same level otherwise). Panel 90 includes a molded shock absorption pad 94 that is integrated (molded together) with the fibers as part of the molded production of the panel 90. Integrated shock absorption pad 94 is adapted to be in a support relationship with individual fibers 92 such that pad 94 provides a support that establishes an upright position (projecting upwards, e.g., directly upwards) at the area in which the pad 94 and each fiber 92 are attached (by way of the molded structure). When installed the bottom surface faces the ground over which it is installed. Panel 90 includes connectors 96 that are configured to extend vertically downward or project from the bottom surface of the panel. Each connector is configured to be a flat tab with diagonal edges and straight vertical sides that can provide a male connector for inserting into a slot, opening, or aperture in an adjacent panel. As shown, there are six connectors 96 distanced apart on the two sides of the panel 90. The distance between connectors can be about equal. Connectors 96 are adapted to be molded in a position where they are disposed near or at the edge of the panel 90, as shown, to facilitate that adjacent turf fibers on a connecting adjacent panel are positioned in a same or similar distance to fibers on the panel 90. This can provide an appearance of a continuous pattern of the same fibers without an easily visible divide or transition in the pattern. In other words, the distance between adjacent panels is such that the distance between the fibers at the edge of each panel appears to be the same as the distance with immediate adjacent fibers on the panel. Panel 90 includes flanges 98 that extend or project horizontally from two sides of the panel 90. As shown, the fibers 92 can be arranged in a dense array of rows and columns.

Panel 90 including fibers 92, pad 94, and other components is configured based on their composition to have a shape memory such that the structure are each elastic or bendable but they in general retain the same shape under normal operating temperatures of 0° F. to 120° F. and repeatedly spring back to that same shape when bent or deformed. There may be some general variation in maintaining shape due to wear, composition variations, or other conditions, which would be understood to those of ordinary skill in the art. The Panel 90 is configured to maintain the shape memory when installed by being easily moved when force of 0.01N amount or less is applied to the fibers 92 or pad 94 but which reverts back from the deformation to its original shape and position.

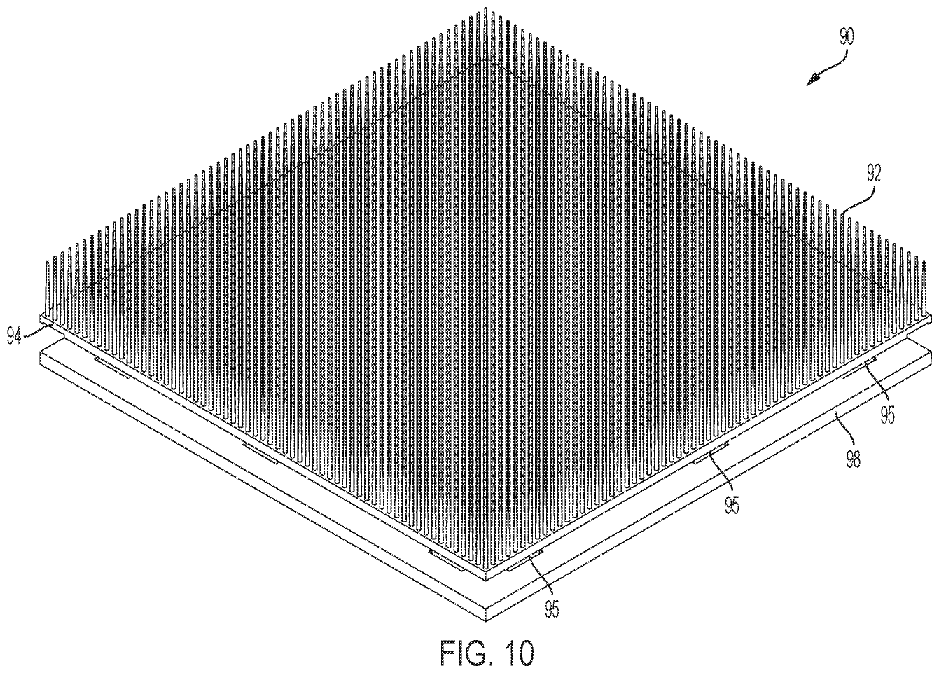

FIG. 10 illustrative a different perspective view of panel 90. In this view, mating portions 95 that receive male connectors 96 are illustrated. As shown, mating portions 95 are configured to be an opening, recess, or aperture, that is adapted to match the dimensions of each connector 96. As shown, portions 95 are configured to be narrow rectangular slots that match the length of a connector 96. The portions 95 are configured to receive connectors 96 such that it is held in place to provide an interconnecting arrangement such as lock, friction-held tabs, or other interconnection structure for attaching adjacent panels to each other. An adjacent panel would be placed over flange 98 and connectors 96 are inserted in portions 95 to assemble the panels. The connectors facilitate the panel position and centering

Fibers 92 are configured to be arranged in a pattern and at a distance in relation to adjacent fibers that adapts panel 90 to have fibers bend, freely bend, in the same direction when a force such as the heel of an athletic shoes is applied and the bend is such that the fibers in combination can establish a pile of fibers bent over each other. The fibers lean forward and pile up against each other due to the force. The fibers, also due to the shape memory and the upright force relationship with the pad 94, create a combined force in the opposite direction (an elastic force to spring back) when they are compressed such as with the heel of an athletic shoe or when a player falls on the panel 92. The panel 90 is adapted to provide increased sport performance as a result of the generally flexibility of the fibers and the close-distanced relationship and physical characteristics of the fibers and their configured attachment (upright support) with the pad 94.

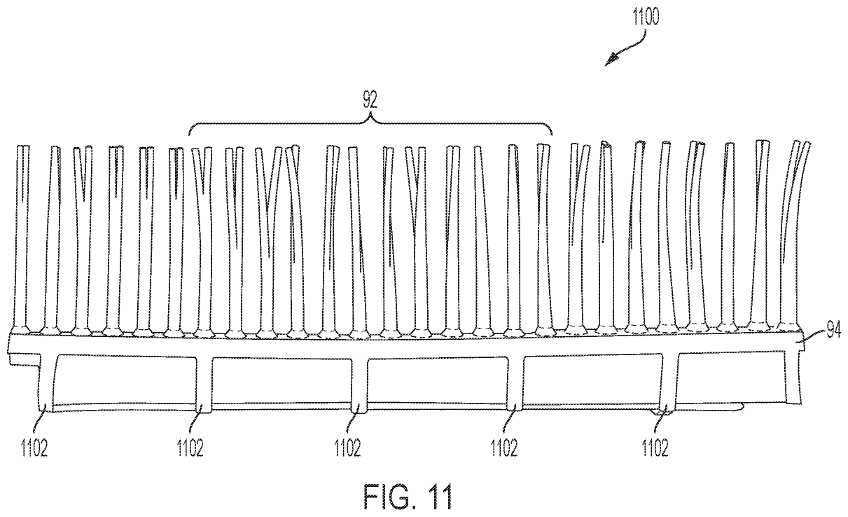

FIG. 11 illustrates a cross section view 1100 of the portion of panel 90. This is an illustration of a photographic image of the structure. Fibers 92 are shown in their post-manufactured state in a preferred embodiment. Fibers 92 as shown illustrate upright fibers that are supported to have the upright position using the integrated supporting attachment to shock absorbing pad 94. As shown, some manufactures fibers have a slight bend or curve that can be due to manufacturing variation or wear. The material of each fiber is also of a certain hardness that maintains the upright structure as result of the upright supporting relationship of the pad, along with the shape of the fiber, the shape memory of the fiber, and the dimensions of the fibers. The structure is found to be provide thin and long molded fibers that provide significant performance improvements, such as foot stability during traction or rotation movements.

Panel 90 can include underside mechanical structures that are formed as part of the mold of the panel. The mechanical structures for example provide structural support that combine with other features to provide improved performance. The structure can include additional shock absorption and impact distribution characteristics. For example, as shown, legs 1102 are adapted to form legs that are distanced apart. The legs 1102 can be configured to create cells that are open at the bottom facing the ground and the walls form the outside structure of the cells. Cells are formed by walls that create an empty space or volume under the pad 94 and fibers 92. The cells are preferably repeated in an adjacent relationship to each other on the underside of the pad 92. The cells can be adapted to cover the bottom side of the panel 90. The cells are configured in the panel 90 to allow the panel to have force distribution and shock absorption as well as lateral stability. The plurality of cells cooperate during deflection under load such that the adjacent cells (or walls cells) provide a load absorption gradient over a larger area than the area directly loaded, a solid layer or block can be implemented in some embodiments as the underside of the panel 90. The cells can be square or rectangle shaped but other shapes are also contemplated. The cells have walls and a void formed by each cell and the cells are configured to flex down at the top wall and sides in response to foot traffic or other impact, thus changing the shape of the void and then in response, flexing back to an original state when the force or weight is removed (due to shape memory) of the panel 90.

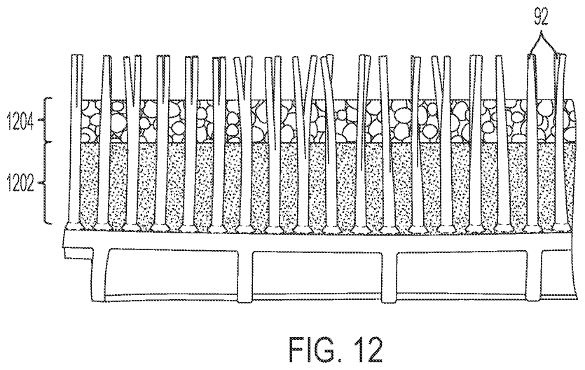

Preferably, the present embodiments are directed to an artificial turf field system for providing artificial surface adapted to provide a surface for athletic activity that meet certain performance requirements, e.g., FIFA or other sports federations specify the field to meet operational performance requirements in order to be used for the sport or for competitive league events. The artificial turf system is preferably configured to include infill particles that are interspersed between the fibers. The total shock, impact, and operational performance of the system are from the combination of the artificial turf panel (such as panel 90), which includes the fibers, pad, and underside cells, and the infill particles interspersed between the fibers. For example, in FIG. 12, a cross section of a portion of panel 90 is provided. As shown, a two-layer infill structure is provided. The first layer 1202 is a stabilizing infill such as sand and in particular, in this example, #20-50 sieve sand at 3 lb/ft². The second layer 1204 is a layer of lighter weight infill particles which comprises a combination of performance infill such as infill marketed by FieldTurf under the name CoolPlay. The second layer is preferably a thinner layer and is adapted to have a weight of 1 lb/ft². A relationship to the fibers 92 is that infill is provided to reach a total height that is ½ to ⅞ of the height of the fiber height. Preferably, the height is at a level equal to about 60% to 85% of the height of the fibers 92. The infill is installed to be have an even height across the field in relation to the fibers.

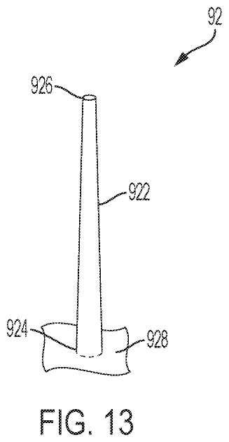

FIG. 13 is a perspective depiction of a fiber 92 as part of panel 90. The figure is provided for illustration purposes to show a single fiber that is implemented as part of the panel structure. Fiber 92 includes fiber wall 922 that forms the shape of the fiber. In this case, fiber 92 has a round or circular cross section that can taper from the base 924 to the tip 926. Fiber 92 is adapted when formed to have a same cross section from the base area extending upwards until for example the tip of the fiber 92. Fiber 92 is preferably a solid molded structure (e.g., without an internal void). Fiber 92 is configured to terminate at base 924 at top surface 928. The top surface 928 is the flat level surface of pad 94. Preferably, the point at which the fiber wall 922 terminates (with the top surface) is at the same level. Base 924 terminates at top surface 928 on all sides and preferably at the same level. This structure can be produced (molded) using individual cylinders for each fiber that extend from the top surface of the pad 94 such that each fiber 92 terminates on the sides at the base where it meets top surface at the same level. Preferably, the termination is configured to exist at least about 50%-75% of the perimeter of the base. The fibers 92 can each have the pad as its support base without requiring an additional molded support that is raised above the top surface 928. Preferably, fiber 92 and fiber walls 922 is adapted to have its own independent base by way of integral attachment to pad 94 at top surface 928 without sharing an integrated base that is shared by multiple fibers at a height above a base level. As is understood from FIG. 13, the fiber and base and molded, they are formed with a molded attachment or molded connection since the base and fiber are molded at the same time and the shape of the mold creates an integrated molded attachment between base and fiber that due to the shape memory of the molded attachment connection applies an upward support to the fiber extending support so as to make it difficult for the fiber to lay flat despite being highly flexible or freely pliable.

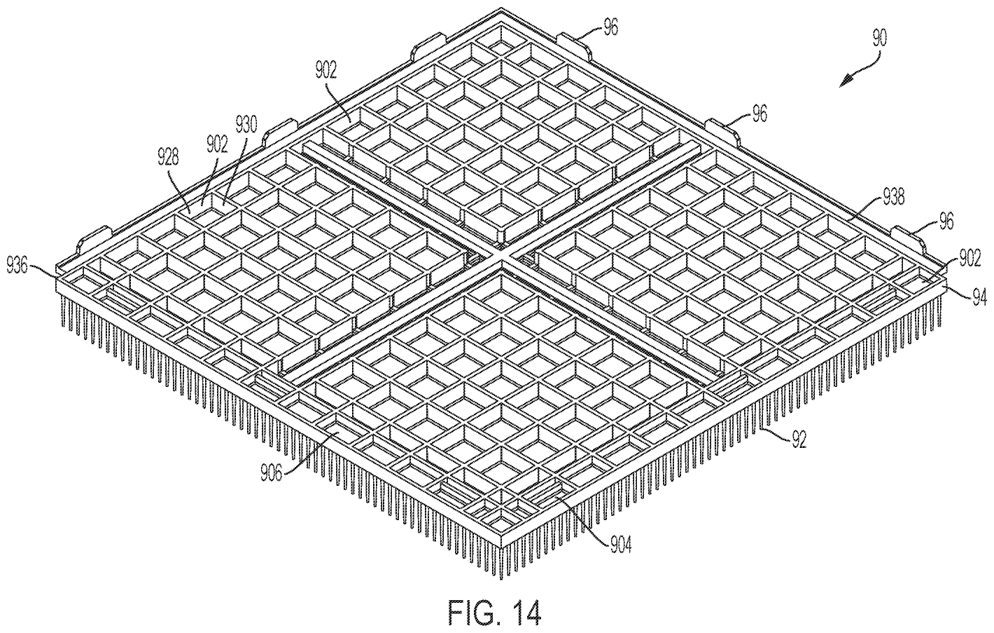

FIG. 14 is a perspective view of the bottom side of panel 90. Panel 90 includes a plurality of square or rectangular cells 902 that are formed to be arranged adjacent to each other on the bottom of panel 90. As shown, panel 90 includes cells having different shapes at the edges 904 and 906. Tabs 96 project from two side of the panel at the panel edges. A portion of pad 94 extends out away from edges 936 and 938 as an upper flange or flap that has fibers on the top side and not cells on the bottom side. When connected this flange rests on top of the flange that comprises the female or mating connector. As shown, cells 902 include sidewalls for example sidewalls 928 and 930. The sidewalls form a cube shaped area that creates a void that together with its cell structure provides a further shock absorption element. The walls of the cells are directly adjoining and preferably, the walls are formed to provide a lengthwise wall that runs, for example, about ¼ to full length of the width of the panel (more specifically, the portion of the panel that includes the cells). The continuous structure of adjoining walls that runs across more than one cell can provide panel rigidity while providing the shock absorption provided by the cells. As shown, the underside can include one or more ribs 932 that include a solid rib of material that runs along the length of the panel (as shown) that can also provide a type of shock absorption cell and improved panel structural characteristics (e.g., limits torsion/lateral deformation to provide additional rigidity while maintaining desired flexibility). The bottom structure using the cells for example is made to configure shock absorption (as part of the overall required shock absorption required for the field or panel) and proper product stability during cutting/direction changing of players shows on the surface. The structure using the voids and walls can be adjusted depending on the resin to increase or decrease the dimensions (e.g., of the walls or size of cells) to fine tune the performance of the pad 90. If desired, the cell on the panel can be in different shapes such as octagons, or cylinders. The cells can be open or closed.

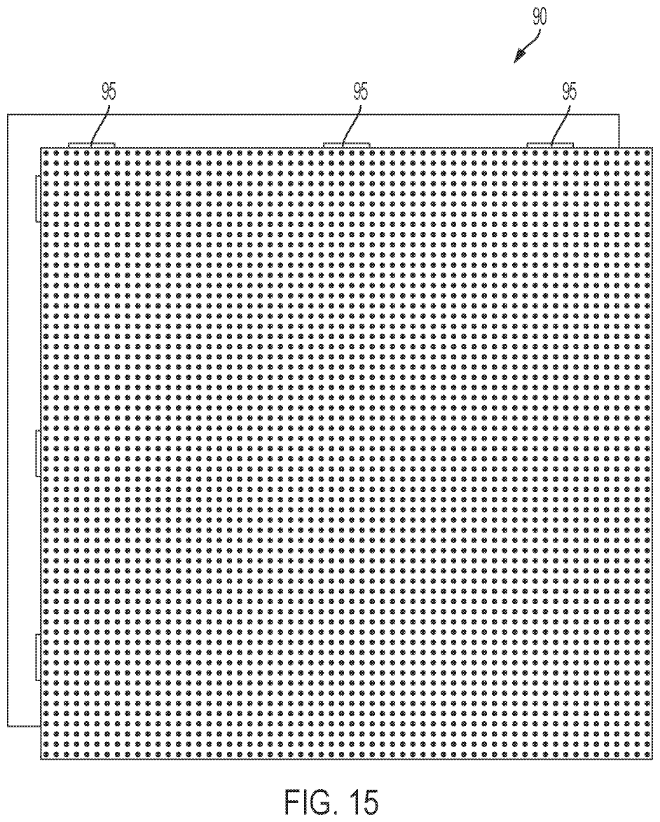

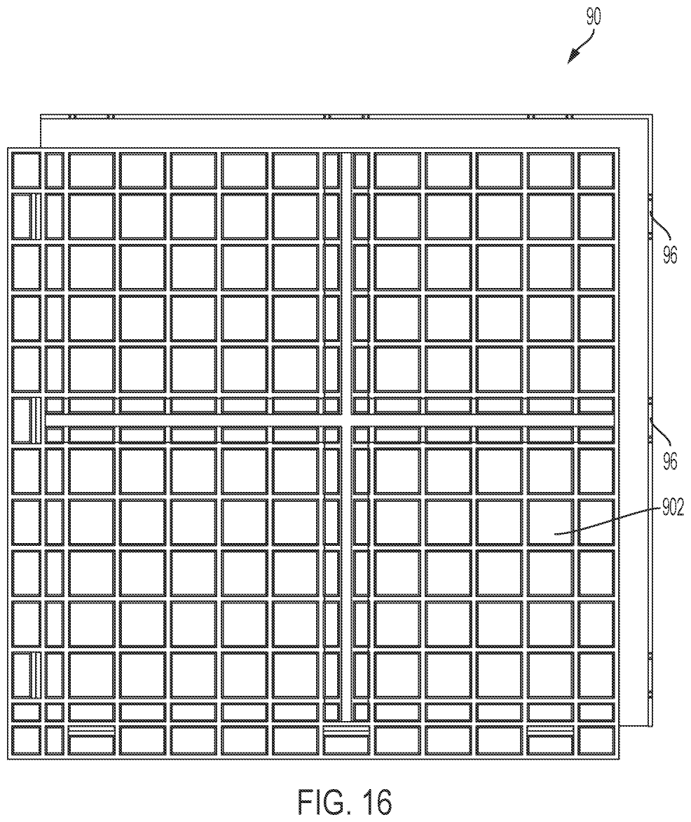

FIG. 15 illustrates a top view of panel 90. Interconnector slots 95 are positioned closely adjacent to the fibers on the top side, which permits when two similar panels are connected to have the fibers on adjacent panels to be closely situated. Interconnector slots are part of a lower flange that receives an overlapping flange of an adjacent panel, the overlapping flange is supported by the lower flange. As shown in the figures, panel 90 is formed to have an operational topside, that is adapted to be used for the playing surface and physical interaction (e.g., play sports), as a continuous surface that flows on the top surface with the same base top surface (the same pad) without holes, breaks, or contours in the flow of the top surface except for the fibers that terminate on the top surface. Some minor holes, breaks, or contours would be understood to be possible in this description in this paragraph without departing from the meaning of the description. One or two holes are not significant, for example. The flow of the top surface, however is generally continuous, even, and at the same level excepts for individual single fiber projections (“generally” in this context means less than +/−5%, preferably less than +/−1% variation in that characteristics across the top surface of the panel). The panel 90 is preferably a continuous molded block without having divided panel portions or formation clusters for forming individual distinct fiber tuft clusters. FIG. 16 illustrates a top perspective view of the bottom side shows a top view of the cells.

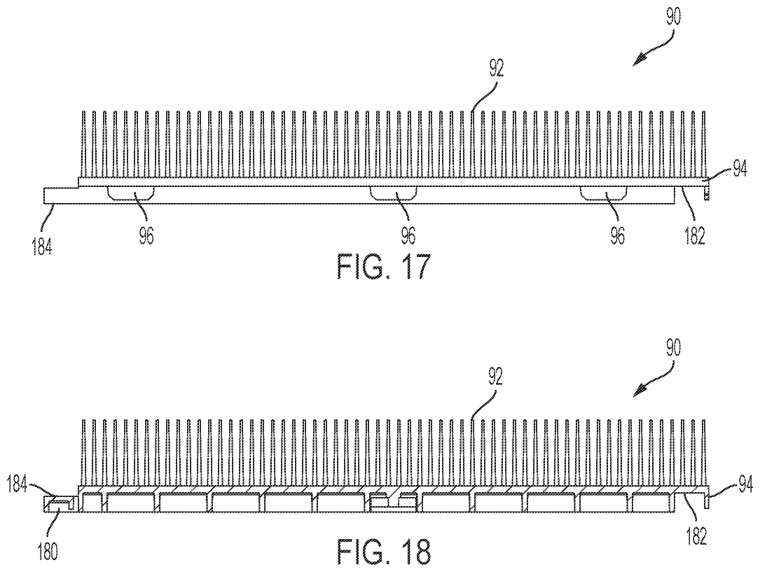

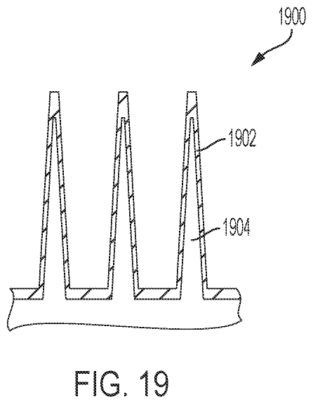

FIG. 17 is a side view of the panel 90 that shows the connectors 96 and different structural relationship. FIG. 18 is a cross section view of the panel 90 at a center portion of panel 90. FIG. 18 shows the walls of the cells in panel 90 and also shows that, in the flanges, there are cells, in this embodiment, that are smaller (smaller cell 180) than the other illustrated cells. FIGS. 17 and 18 are also helpful in illustrating position and shape of top flange 182 and bottom flange 184. The figures are also illustrative of the relative height of the different components, fibers 92, bottom portion (involving pad 94, cells, flanges, and connectors).

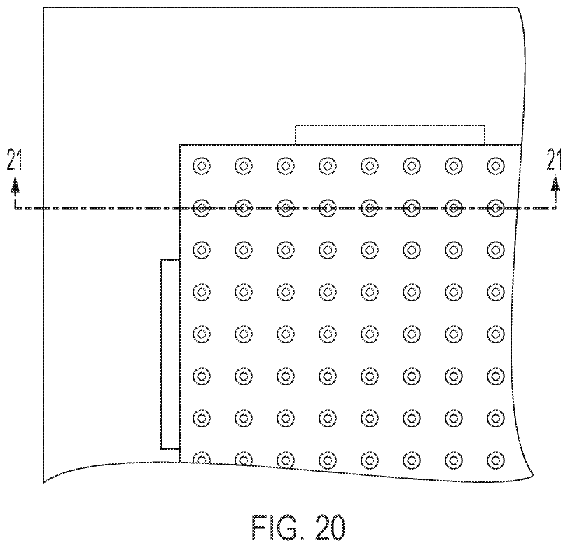

FIG. 19 is a simplified illustration of a mold as part of the manufacturing process. Mold 1900 is illustrated to show a portion of the mold for the manufacturing process. Mold 1900 includes cylinders 1902 adapted to form the corresponding (individual) fibers 1904 in each cylinder. The illustration is simplified to show the mold 1900 and fibers 1902 being separated after the polymer material has been injected into the mold and has cured to its final state. fibers 1904 are shown to have a generally cylindrical shape that matches the other figures but are potentially simplified in view to allow for better comprehension. In production, the molding of thin long fibers that extend from a flat surface can be challenging. In some prior are molding processes, a multiple wider cylinders are used that each contains multiple fibers because it is easier to inject the polymer material in the wide cylinders. The present embodiments of the manufacturing process use individual fiber cylinders. Other variations are contemplated (such as to having cylinders that each include recesses for jointly forming a group of fibers in the cylinder using the recess where for example the middle of the cylinder that connects the fibers is at a higher level that then height of the support) depending on the embodiment of the present invention.

A resin is selected for use to form the molded pad to provide the desired characteristics such as shock absorption and durability. The resin should have the following physical and chemical characteristics, high fluidity when injected to properly fill out the mold print, adequate softness (Shore A between 40 and 80), high memory form (for stepping resistance), and excellent tensile elongation (to allow unmolding). In implementation and testing, Evoprene G968 (having Shore A=47) is mixed with Evoprene grade G969 (shore A=65) to provide an appropriate softness of Shore A around 58/60). Evoprene is a product of Mexichem Specialty Compounds Inc. An alternative resin is Dynaflex resin which has a declared Shore of 60. To generalize, hardness can be in the range of about 55-65 Shore A (which be understood to mean about 55 to about 65). Other ranges described herein are also contemplated. Preferably an unmolding additive is included such as Licowax from Clariant at 0.25%. In the testing conducted on illustrated samples, the material of the molded structure had a Shore A of 59. It would be understood to those of ordinary skill in the art that other minor additives may be included such as color pigments, antioxidant, UV stabilisers, that do not change or do not change by more than a negligible amount the softness or physical characteristics of the fiber. For example, the material for making the molded structure can be made up of 98% of the Evoprene mixture or Dynaflex and the remaining portion can be additives. Evoprene and Dyanflex are, as available public datasheets show, a styrene ethylene butylene styrene block copolymer that is sold as a resin. Preferably, the polymer material used in molding the panels has low viscosity (high Melt fox index), a very liquid polymer, to fill out all tiny mold cavities to creates strands, is outdoor grade (for exposition to sun and atmospheric pollutant) versus others grade such as acid or oil, has high resistance to tear and elongation (to resist during unmolding step, as well as onsite wear), and has excellent resistance to cyclic compression, in other terms a good memory form helping strands keeping their original position after being stepped-on.

The fibers are configured with the described softness are flexible and pliable. They can be easily moved to different positions or be stretched due to shoe heel/shoe stud's exertion. The fibers are not stiff or rigid (stiff or rigid meaning they are not easily bent or require heat after the fiber is molded to create a bend in the fiber for its desired application). The manufacturing and installation process preferably does not require a step after the panel is molded to apply heat to the fibers to bend them to have a certain curve or direction. The fibers of the presentation are highly flexible and can bend or flex with general application of force and then revert back (repeatedly) to an original state (the memory set shape at which it was originally formed).

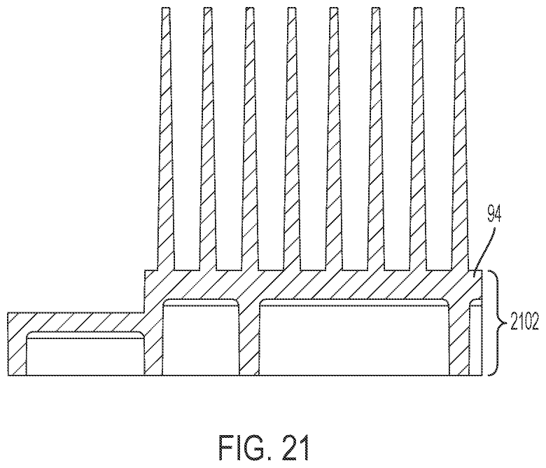

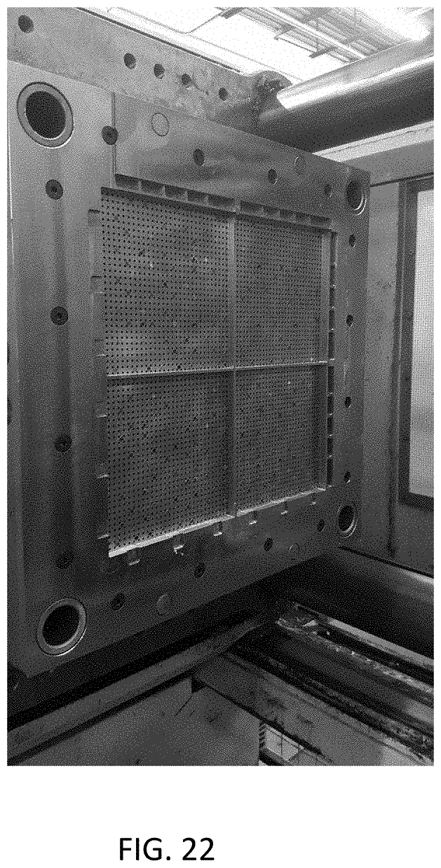

FIG. 20 illustrates a top view of a portion of panel 90 in one embodiment that shows dimensions. The figures show that the fibers on a panel are distanced apart by 0.2 inches (each is equally spaced apart) and the fibers at the edges are a distance of 0.1 inches to the edge. This measured form the center of the fiber. FIG. 21 illustrates a cross-section view of FIG. 20 at line B-B. The figures show a better view of the cells from earlier figures. The figure shows that the fibers are adapted to have a height of 1.25 inches and a thickness at the base of 0.08 inches that (as shown uniformly) tapers to a tip having a thickness of 0.036 inches. As described herein variations are also described herein. The height of supporting portion 2102 from the top surface where the fibers terminate to the bottom as shown is 0.5 inches. The height can be in the range of 2 mm to 40 mm, and preferably in the range of 4 to 25 mm. Pad 94 as part of the overall structure, which also forms the top wall of the cells is, as shown, 0.125 inches thick (top to bottom as shown). Other ranges for the pad are also contemplated.

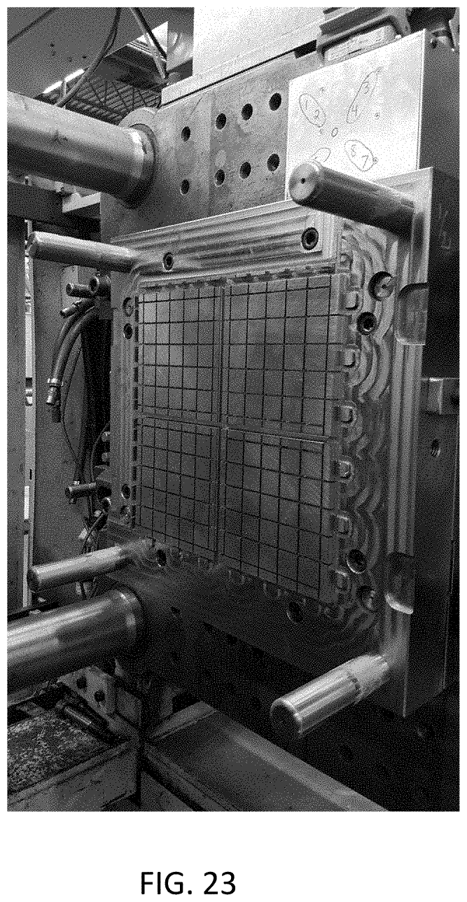

FIGS. 22 and 23 are photographic images of the mold that is used to create the panels 90. FIG. 22 shows an array of holes in columns and rows, which are the recesses for the cylinders (in this case each is shaped in the recess to have narrower taper from the base where the hole is formed). The image also shows that holes are formed and establish a transition to the level surface of the pad where the fibers when formed by the mold terminate around the perimeter of the fiber at the base at the level of the flat surface. It is evident that the fibers and the flat surface from each they extend from (based on the resin forming along the cylinder and surface) are formed using the mold by injecting melted resin into the space established by the mold and establishing pressure within the mold. FIG. 23 illustrates the other side of the mold for forming the back side of the panel having cells, which in this embodiment are shaped as rectangular or square shaped cells. The integrated combined shock absorbing panel and turf fiber is formed when the mold is closed and the elastomeric resin is injected into the heated mold under high pressure to form the structure such as the fibers, cells, connectors, and other features. As shown, the mold produces a single panel that is about 1 foot by 1 foot each, which is used in the research and testing to demonstrate the performance improvement offered by the current system. Larger panels are contemplated that would place adjacent to each out to form a playing field and playing surface. The structure of the molding machine includes plungers that are shown in FIG. 22 as different circles on the flat operational surface of the mold that include the fiber cylinders that are used to push out or away the panel when the mold is being opened to separate (push) the panel away from the mold to allow it to detach. The unmolding additive is included to allow the fibers to more easily eject with the help of the narrow cylinders (ejectors) while maintaining most or substantially all of the fibers to be intact (meaning none or only a small portion of a tip of fibers is broken when the mold is opened and at a small percentage such as about 1% of the fibers.). In some embodiments of the present invention, the fibers for a panel are formed together in the mold at the same by the method described herein versus a serial process in which individual fibers or tufts of fiber are formed in series and arranged to form a plane for the field surface afterwards by arranging them into an array). In some embodiments of the present invention, the latter is contemplated and would be part of the manufacturing process.

The manufacturing and implementation process includes providing a mold, as described herein, prepare a compound made of elastomeric polymer and additives to be used in the mold, injecting the melted resin/compound into the mold; applying heat and pressure to the melted resin in the mold to fill the print (including cylinders) in the mold and the contours of the mold, cooling down the polymer resin the hold to the point that it sets to be a solid (e.g., single solid structure, a single undivided molded panel), opening the mold, eject the formed molded individual solid panel (or panels if multiple are formed together) from the mold. No more industrial action is required and panels can be used a few minutes after their production using injection molding. The panels are then placed on a surface such as a level ground surface in connecting or adjacent pattern to establish a covering for the surface. Infill particles are dispersed in between to the fibers on the placed panel to establish an infill to particular level on top of the pad and below the tips of the fibers. The fibers are installed on the field with the panels and after the molding the process the fibers are installed and/or used as an operational field without additional deformation treatment to bend the fibers. Without additional deformation treatment means without an additional applying heat or molding process using a heating or molding tool that applies heat to the fibers where the heat process is designed changes the shape memory or the physical structure of the individual fibers to have a different shape memory in a more than minimal or negligible amount, meaning more than 10% in shape from first to a second position, such as heating it to create a fiber to have a particular curve. The panel and fibers can be installed on the field without additional processing to change the shape memory or structure of fiber or panel. It would be understood that this not referring to changes that may occur from expected mechanical or temperature wear of the fibers of the field after installation from use of the field. Variations such as multiple stages, steps or different sections are contemplated. The panel is as shown a single block or structure that is formed at once in the mold.

In some implementations, the mold fibers are the panel are adapted to remain upright and return to a memory shape position of being upright (or about upright) if force is applied to the fibers. Applying a grooming or other similar preparation process may not be needed or necessary in such embodiments. In some embodiments, the molded fibers of the playing surface have a natural lean in an initial state, without having the spring characteristic to return to an initial shape of being upright (or about upright), due to the weight of the fiber in relation to the height, thickness, and hardness of the material, upright with a natural lean or curve. In such embodiments, it may be preferred to apply a grooming or similar treatment (e.g., grooming such as that performed on conventional artificial turf fields to prepare the playing surface for athletic activity).

Testing of the panel illustratively shown and described in connection with FIGS. 9-18 and 20-21, involving the above mention infill, the panel physical characteristics (fiber length and width shown in FIG. 21) has provided surprising results in that the installed artificial turf using the panel has the same or similar performance characteristics as natural grass. Testing has shown that the force reduction is 62% compared to natural grass, which is 64% (using Labosport for testing). Testing has shown that impact attenuation is 111G compared to 108 G for natural grass (using Labosport for testing). Testing has also shown that Head Injury Criterian (“HIC”) helmeted at 0.5 m is 84 HIC compared to 82 HIC for natural grass. This testing with this example shows and would be understood to that present invention provides advantageous performance in accordance to the present description and with respect to the specific example. Testing communicates that the present invention is advantageous and in general will preform similarly in other configurations as well as that illustratively described herein and the surprising performance is not necessarily limited to the test configuration. Generally, in this field, it is significantly meaningful to provide playing a surface that performs in a similar way (or in an improved way) to natural grass. Testing of the panel has shown that the performance characteristic of the present structure as for example shown in FIGS. 9-18 and 20-21 provides a similar performance or better simulates natural grass across a range of physical testing and operation. For example, testing two characteristics, one to measure reduced power rotation and another to measure full power rotation, using two different types of athletic shoes has shown that across the range of 0 to 100 theta (deg) the example panel used in the present testing (illustrated in FIGS. 9-18) had a similar or substantially the same performance response as natural grass in both types of test. The results also showed in certain range of degrees, conventional artificial turf field (tufted fibers with convention two-layer infill) performed worst than the present panel. This is surprising and unexpected in that known conventional artificial turf system do not provide such a similar performance profile to natural grass across a range of performance testing.

In preferred embodiments, the fibers are fixed at the base and freely bendable or pliable with shape memory that reverts it to an original state. Freely bendable or pliable means that the fiber is not rigid and is adapted to bend easily out of its initial state (the initial state set by shape memory when formed) when at least very low physical manipulative force of 0.01N is applied and maintained at the top or about the top half of the fiber portion, which forms a curve across the profile of the fiber towards the base where it terminates, and when the force removed the fiber (immediately) springs back to or about the shape of its shape memory. In preferred embodiments of the present invention, the panel comprises freely bendable or pliable fibers that terminates at level of surface of an integrated pad.

As is evident from the figures, the fibers are molded to have a shape and characteristic in which they fibers are not designed to fall or move toward predetermine direction or way. The fibers are configured to be freely bend in all direction and can do depending on the direction of the force. The structure of the fiber and support is not configured to direct the fiber in one direction over an other direction because of the shape, structure, or attachment of the fiber and base (the support surface).

A combination of features such as the hardness, physical structure, relationship to other parts, material and/or other features or advantage make embodiments of the present invention unique and distinctive. This can include the durability of the fibers. The fibers as formed in embodiments of the present invention are durable such as they retain their original physical characteristic and can withstand repeated use by way of foot traffic over a period of years (e.g., 8 years) without breaking except for potential a small percentage of cases (such as less than 3-5% of the fibers).

In addition, the panel is configured to have an excellent puncture performance or surface resistance to puncture. For example, the molded panel of embodiment of the present invention can be capable of receiving direct pressure by a shoe heel or cleat for up to 400 lbs of force without being punctured or torn. The structure is such that the surface resists puncture from sharp heels. This is a tougher surface feature than many types of panels that use foam or expanded beads.

A significant amount of testing involving trial and error was performed to develop the present described characteristics that provide similar performance to natural gas or other improvement. The describes structure, features, and embodiments are not evident simply from genera information but a process of continues testing and evaluations was performed to arrive at the present embodiments. Embodiments of the present can be characterized by the physical and structural relationships described herein.

In some embodiments, embodiments of the present invention provide an artificial turf system in which shock absorbing pad is formed to include molded fibers as part of the pad that configured a playing surface on the top side of the pad comprising an array of the molded fibers that are adapted to be in sufficient density to provide paying surface for athletic performance. The array of fibers, as also discussed above, can be adapted to be in rows and columns across the surface of the pad. The arrangement of the fibers to form the array can include random distribution or variable distribution without having the even columns and rows, or can include combinations thereof to provide the play surface.

Embodiments described herein can include panels in which fibers are formed in cluster or tufts having the same base as opposed to each fiber have its own separate base as illustratively described herein.

Preferably, the panel (including for example the support substrate, cells, or flanges) is adapted to be soft (easily compressible by fingers) and flexible based on the hardness of the material, the type of material from which the panel is made (as described herein). As such, that panel (including supporting substrate) can bend or flex as opposed to be a rigid structure (with minimal or negligible torsional flexibility). Preferably, when the panel (including substrates and fibers) are molded using the same material, as described herein, the features of the panel are adapted to have excellent shape memory, the fiber or other elements recover to the same position after an impact.

As would be understood from the above description, the panel is configured to for deflect under load, thereby imparting impact absorption to the panel.

As described in embodiments of the present invention, the panel is adapted to has a supporting surface as part, of the pad, where the supporting surface has a generally continuously flat top surface except for fibers that molded to extent above the surface.

As is understood from the present description, an impact absorption layer can be provided for an artificial turf field comprising an assembly of the present panels, wherein each panels includes molded artificial grass fibers (molded into the panel or support) for providing the playing surface of the field.

The top surface of the panel is generally flat to allow for even distribution of infill but there can have variation.

If desired, other applications (such as playgrounds) of the artificial turf field and panels in accordance with some embodiments of the present invention are contemplated.

The fibers and top side of the panels are adapted to or configured for, in accordance with some embodiments of the present invention, to receive the impact of shoes or other human activity as the objective and implementation of the system. The fibers are not configured to be a support surface for other things since the fibers are not rigid support structures. If an object is positioned over it, based on the weight of the object, the pile of the fibers would bend and compress and remain compressed until the object is removed.

In some embodiments, it is contemplated features of the artificial turf, structure, or panel, described herein is a separate, divided or distinct piece that is attached such as by an adhesive to form a structure such as the panel. For example, a structure providing the cells can be attached to another piece that provides the molded base and fibers extending from the base.

Unbiased refers to the lack of an external mechanical force being applied to the surface of an object (e.g., a fiber extending upright without any directional manipulative force being applied to the column of the fiber).

Excellent memory form or shape memory means for example that the when subject to a cycling test that mimics stepping (compaction and compression), the measured recovery of the fiber to its original position is more than 90% after 5000 cycles of an applied force of about 2 kN.

Post processing or mold shapes to add structural functional features are contemplated without departing the principles generally described herein.

The term soft is generally understood to those in the field of polymers and artificial turf field. Soft for example can refers to having a characteristic that material deformation occurs under low pressure or force, material provides a high shock absorption, and fiber bends easily under low pressure

All dimensions recited herein are approximate and can vary by as much as ±10% to in some case±25%. In some situations, the term “about” is used to indicate this tolerance. And when the term “about” is used before reciting a range, it is understood that the term is applicable to each recited value in the range.

Therefore, in sum, it is to be realized that the optimum dimensional relationships for the parts of the invention can include variations and tolerances in size, materials, shape, form, function and use are deemed readily apparent and obvious to the skilled artisan, and all equivalent relationships to those illustrated in the drawings and described in the specification are intended to be encompassed by the claims appended hereto.

Unless defined otherwise, all technical and scientific terms used herein have same meaning as commonly understood by one of ordinary skill in the art to which this invention belongs.

A mention of a range is understood to include the end points of the range.

The terms “may” or “can” are used in a similar was as “is” to express that this is one embodiment and others may exist.

The use of “a” or “an” is general understood to mean one or more unless the context or convention understood by one of ordinary skill in the art would be different.

Any sequence(s) and/or temporal order of steps of various processes or methods (or sequence of device connections or operation) that are described herein are illustrative and should not be interpreted as being restrictive. Accordingly, it should be understood that although steps of various processes or methods or connections or sequence of operations may be shown and described as being in a sequence or temporal order, but they are not necessarily limited to being carried out in any particular sequence or order. For example, the steps in such processes or methods generally may be carried out in various different sequences and orders, while still falling within the scope of the present invention. Moreover, in some discussions, it would be evident to those of ordinary skill in the art that a subsequent action, process, or feature is in response to an earlier action, process, or feature.

It should be understood that claims that include fewer limitations, broader claims, such as claims without requiring a certain feature or process step in the appended claim or in the specification, clarifications to the claim elements, different combinations, and alternative implementations based on the specification, or different uses, are also contemplated by the embodiments of the present invention.

Exemplary systems, apparatus, devices, and methods are described for illustrative purposes. Further, since numerous modifications and changes will readily be apparent to those having ordinary skill in the art, it is not desired to limit the invention to the exact constructions as demonstrated in this disclosure. Accordingly, all suitable modifications and equivalents may be resorted to falling within the scope of the invention.

1. An artificial turf system that provides a playing surface for conducting an athletic or sporting activity, comprising
a plurality of soft polymer molded artificial turf panels, wherein each of the panels has edges and comprises one or more connectors that connect to an adjacent one of the panels, each of the panels comprising an array of artificial turf fibers, each of the fibers has and retains a shape memory adapting each of the fibers to have an upright state in an unbiased state and each of the fibers is also freely pliable,
wherein the panels are connected adjacent to each other to form a field of the artificial fibers that together establish the playing surface on the field for an athletic or sporting activity.

2. The artificial turf system of claim 1 wherein each of the fibers terminates at a supporting surface of the panel at the same level of termination around perimeter of the fiber.

3. The artificial turf system of claim 2 wherein the supporting surface is in a supporting relationship that projects each of the fibers individually upwards.

4. The artificial turf system of claim 1 wherein each of the panels includes a plurality of open cells formed from panel underside walls that absorb shock and provide deformation when the panel is in use.

5. The artificial turf system of claim 1 wherein the fibers are long thin fibers that taper from a terminating position to a tip of the fiber.

6. The artificial turf system of claim 1 wherein the support surface is generally flat and each of the fibers terminates at the support surface.

7. The artificial turf system of claim 1 further comprising infill particles that are interspersed between the fibers.

8. The artificial turf system of claim 1 wherein the panels are configured to include flanges that overlap when the adjacent panels are connected.

9. The artificial turf system of claim 1 wherein the panels are configured to have different shaped cells on the bottom of each of the panels.

10. The artificial turf system of claim 1 wherein an array of adjacent cells is formed on the bottom side of each of the panels.

11. The artificial turf system of claim 1 wherein the fibers are made of the same material as its attached base, forming a single panel.

12. The artificial turf system of claim 1 where the fibers have an excellent memory form and have a capability to stay upwards after exposure to stepping.

13. A method providing an artificial turf field, comprising:
providing a mold comprising an array of separate cylinders, each cylinder for forming an individual freely pliable fiber and an integrated attached shock absorbing support substrate from which each fiber would project upward due to the supporting relationship of the substrate as a base for each fiber;
injecting melted elastomeric polymer into the mold and applying pressure to the injected melted elastomeric polymer in the mold;
cooling the injected polymer in the mold to form an artificial turf panel formed as a solid piece comprising an array of molded fibers molded at the same time with the substrate, wherein the fibers are freely pliable; and
removing the panel from the mold.

14. The method of claim 13 wherein each of the molded fibers is formed to be individual and distinct and terminates at a generally flat surface of the support substrate.

15. The method of claim 13 wherein the elastomeric polymer is SEBS.

16. The method of claim 13 wherein the elastomeric polymer has a hardness equal to Shore A in the range of about 40 to 80.

17. The method of claim 13 further comprising placing the panel on a field as part of artificial turf field for an athletic activity without applying any additional industrial steps or additional deformation treatment to the fibers.

18. The method of claim 13 further comprising interspersing infill between the fibers when installing the panel on a field.

19. The method of claim 13 wherein the mold is adapted to form flanges on the panel, which in use are used in connecting adjacent panels.

20. The method of claim 13 comprising forming one or more connecters at one or more edges of the panel that connect the panel adjacent similar panels.

21. A shock absorbing artificial turf panel comprising
a panel comprising a top side, bottom side, and edges, the top side comprising an array of freely pliable fibers that are adapted to provide a playing surface and a base that supports the fibers to be in an upright relationship by molding the base and the fibers, wherein the fibers and base are made of the same elastomeric polymer.

22. The shock absorbing artificial turf panel of claim 21 wherein the fibers and base are of the same elastomeric polymer that has a hardness in the range of about 40 to 80 Shore A.

23. The shock absorbing artificial turf panel of claim 21 wherein the fibers have a circular cross section and have a profile that is thicker at the base than at a tip of the fiber.

24. The shock absorbing artificial turf panel of claim 21 wherein the panel is configured to include cells positioned on the bottom side of the panel that provide shock absorption from foot impact.

25. The shock absorbing artificial turf panel of claim 21 wherein the panel include one or more connectors at the edges of the panel that are configured to connect to similar adjacent panels.

26. The shock absorbing artificial turf panel of claim 21 wherein the base is a generally flat surface except for attachment points of the fibers.

27. The shock absorbing artificial turf panel of claim 21 wherein the fibers are equally spaced apart on the base.

28. The shock absorbing artificial turf panel of claim 21 wherein each of the fibers terminates at the base at the same height.

29. The shock absorbing artificial turf panel of claim 21 wherein the freely pliable fibers are adapted to have shape memory comprising an upright or about upright shape that each fiber returns to after impact including shoe stepping.

30. The shock absorbing artificial turf panel of claim 21 wherein the freely pliable fibers are adapted to have shape memory comprising an upright or about upright shape without a natural lean or curve.
